(19) United States
(12) Patent Application Publication
(10) Pub. No.: US 2022/0285704 A1
(43) Pub. Date: Sep. 8, 2022

(54) CO2-NEUTRAL OR NEGATIVE TRANSPORTATION ENERGY STORAGE SYSTEMS

(71) Applicant: Northwestern University, Evanston, IL (US)

(72) Inventors: Scott A. Barnett, Evanston, IL (US); Travis Schmauss, Evanston, IL (US); Matthew Lu, Evanston, IL (US)

(21) Appl. No.: 17/630,212

(22) PCT Filed: Aug. 4, 2020
(86) PCT No.: PCT/US20/44838

§ 371 Date: Jan. 26, 2022

Related U.S. Application Data
(60) Provisional application No. 62/882,775, filed on Aug. 5, 2019.
(60) Provisional application No. 62/940,316, filed on Nov. 26, 2019.

(51) Int. Cl. H01M 8/04119; H01M 8/04111; H01M 8/04082; H01M 8/12

(52) U.S. Cl. CPC H01M 8/04179; H01M 8/04111; H01M 8/04201; H01M 8/12; H01M 2008/1293; H01M 2250/20

(57) ABSTRACT

Motorized vehicles are provided which may a device configured to convert a fuel comprising a hydrocarbon, an alcohol, or both, to an exhaust comprising CO₂; and a tank configured to store, under pressure, the exhaust comprising CO₂ and an inlet port configured to receive the exhaust from the device. The device may be a solid oxide fuel cell (SOFC). The tank may be a co-storage tank configured to store, under pressure, the fuel comprising the hydrocarbon, the alcohol, or both, and the exhaust comprising CO₂, the co-storage tank further comprising an outlet port configured to deliver the fuel to the device. Methods of using the motorized vehicle are also provided.

### CROSS-REFERENCE TO RELATED APPLICATIONS

The present application claims priority to U.S. provisional patent application No. 62/882,775 that was filed Aug. 5, 2019, and U.S. provisional patent application No. 62/940,316 that was filed Nov. 26, 2019, the entire contents of both of which are incorporated herein by reference.

### REFERENCE TO GOVERNMENT RIGHTS

This invention was made with government support under DE-SC0016965 awarded by the Department of Energy and under 1545907 awarded by the National Science Foundation. The government has certain rights in the invention.

### BACKGROUND

CO₂ emissions from the transportation sector comprise a significant portion of total greenhouse gas emissions. Although CO₂-neutral options including battery electric vehicles and hydrogen fuel cell vehicles are being introduced, significant issues remain especially related to storage energy density and specific energy, cost, and infrastructure requirements. Hydrocarbon fuels are also a possibility assuming that they are produced from a renewable energy source, such as biogasification or electrolysis driven by wind or solar electricity. Hydrocarbons have a significant advantage in that they have much higher energy density than compressed H₂ or lithium-ion batteries. However, even in scenarios where a renewably-produced hydrocarbon fuel is utilized, the resulting CO₂ product is released into the atmosphere. While CO₂ removal from the atmosphere for use in the further production of renewable hydrocarbon fuel is possible, atmospheric extraction introduces considerable additional complexity, cost, and energy loss due to the relatively low CO₂ concentration.

### SUMMARY

In one aspect, a motorized vehicle is provided, the vehicle comprising a device configured to convert a fuel comprising a hydrocarbon, an alcohol, or both, to an exhaust comprising CO₂, and a tank configured to store, under pressure, the exhaust comprising CO₂ and an inlet port configured to receive the exhaust from the device. In embodiments, the device is a solid oxide fuel cell (SOFC). In embodiments, the tank is a co-storage tank configured to store, under pressure, the fuel comprising the hydrocarbon, the alcohol, or both, and the exhaust comprising CO₂, the co-storage tank further comprising an outlet port configured to deliver the fuel to the device. Methods of using the motorized vehicle are also provided.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 shows a schematic diagram of a dual chamber, fuel/exhaust storage tank according to an illustrative embodiment.

FIG. 2 shows a schematic diagram of an energy storage system according to an illustrative embodiment. In the system, the co-storage tank of FIG. 1 is operatively connected to a solid oxide fuel cell (SOFC).

FIG. 3 is a plot of density versus pressure for two representative temperatures of CO₂.

FIGS. 4A and 4B are plots of volumetric (FIG. 4A) and gravimetric (FIG. 4B) energy densities of representative fuels and resultant CO₂ exhaust after combustion. Comparison of CO₂ and fuel storage volumes for a given reaction enthalpy (energy released), for representative fuels. For the CO₂ and gaseous fuels, tank pressures of 250 or 700 bar are used. Also shown for are values for hydrogen and Li-ion batteries. GJ is used as a convenient measure, since 1 GJ corresponds to the energy in 7.7 gallons, or 29 l, of gasoline, approximately the size of a typical automobile fuel tank.

FIG. 5 shows a schematic diagram of another energy storage system according to an illustrative embodiment, operatively connected to a vehicle.

FIG. 6 shows a schematic diagram of an energy storage system according to an illustrative embodiment, operatively connected to a fuel filling station. The fueling station comprises a fuel tank (to provide the fuel) and a CO₂ tank to accept CO₂ exhaust from the system for use in an electrolysis/catalysis system or for pick-up for later storage or conversion back into fuel using renewable electricity.

### DETAILED DESCRIPTION

Provided are energy storage systems, components of such systems, and related methods. The systems may be characterized as being CO₂-neutral and in illustrative embodiments, CO₂-negative. The energy storage systems may be used to store CO₂-containing exhaust in a variety of types of motorized vehicles and in embodiments, to co-store both the exhaust and a fuel to power the motorized vehicle.

Co-Storage Tanks and Energy Storage Systems

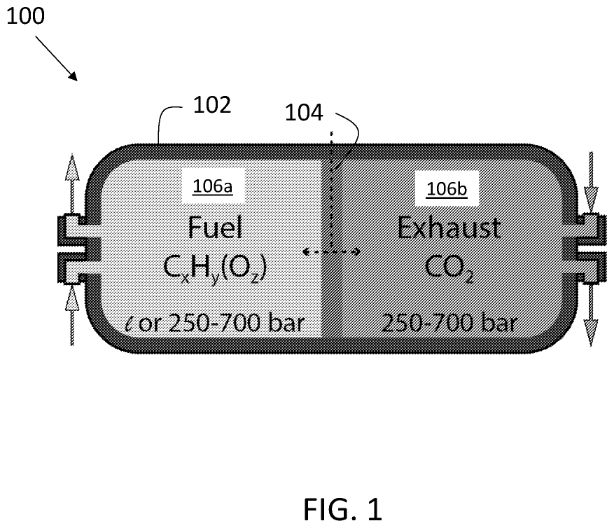

In embodiments, energy storage systems are provided which are based on storing both fuel and exhaust comprising CO₂ in a single tank. An illustrative embodiment of a co-storage tank 100 is shown in FIG. 1. The tank 100 has walls 102 configured to contain fluids (i.e., liquids and/or gases) under pressure (i.e., pressurized fluids). In this embodiment, the walls 102 define and a partition 104 separates two chambers, one chamber 106a in which fuel may be stored and another chamber 106b in which exhaust may be stored. The partition 104 is generally self-adjustable in that its position and/or shape changes in response to changes in the volume of the fuel and/or exhaust in the respective chambers 106a, 106b. This may be achieved by the partition 104 being moveable such that it can translate within the tank 100 and/or by being made of a flexible material. As the fuel is used, the tank 100 is increasingly filled with the CO₂ product. The CO₂ may be off-loaded during re-fueling for use in producing fuel or external storage (further described below). The partition 104 (and walls 102) is generally composed of a material(s) impermeable and inert to the contents of the fuel and the exhaust. Arrows are used to represent fuel inlet and outlet ports and exhaust inlet and outlet ports of the tank 100. In this way, the tank 100 may be operatively connected to (e.g., to provide fluid communication with) other components. In other illustrative embodiments of a co-storage tank, a partition is not needed, e.g., when the fuel and the exhaust exist in different phases or immiscible phases.

Chamber volumes and pressures, both of which determine suitable sizes for the chambers 106a, 106b, and thus, overall tank 100 size, are described further below. Since the inventors have determined that fuel and CO₂ volumes are similar for most fuels, dual-chamber, co-storage tanks such as tank 100 significantly reduce total tank volume and also cost. Besides minimizing CO₂ emission, this on-board capture approach also has substantially lower cost compared to atmospheric capture of CO₂.

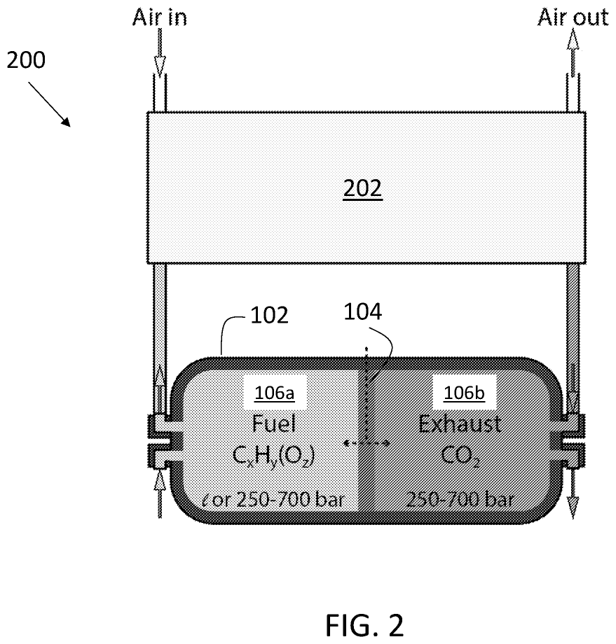

To achieve reasonable co-storage tank volumes, the fuel stored therein is reacted with pure oxygen rather than air. This prevents CO₂ from being diluted with large amounts of N₂. To achieve this, FIG. 2 shows an energy storage system 200 in which the co-storage tank 100 is operatively connected to a solid oxide fuel cell (SOFC) 202. (As used in the present disclosure, the term “SOFC” encompasses an individual SOFC as well as a stack of SOFCs.) Although air is used as the oxidant source in SOFCs, its electrolyte membrane allows only oxygen transport, such that it acts as a membrane separator, reacting the fuel at the anode with pure oxygen. In addition, SOFCs provide much higher conversion efficiency, 50-60%, than typical transportation heat engines (10-40%). In other embodiments, a SOFC (such as the SOFC 202) may be replaced by an oxygen (O₂) generator operatively connected to a heat engine (e.g., an internal combustion engine, a turbine, etc.)

As also described below, co-storage tank sizes are found to be within a factor of two of common liquid hydrocarbon fuels (gasoline, diesel). Tank sizes are even more comparable given the higher SOFC conversion efficiency compared to existing internal combustion heat engines, such that less fuel is required for a given distance traveled. Moreover, a key advantage compared to hydrogen fuel cells is that the present co-storage tank is about 3 times smaller compared to hydrogen tanks and the pressure needed and energy required for compression is much reduced. In addition, although the mass of the stored CO₂ product is 2-3 times greater than that of the fuel, the mass is still much reduced compared to battery electric vehicles.

Fuel and Exhaust Storage Volume/Mass

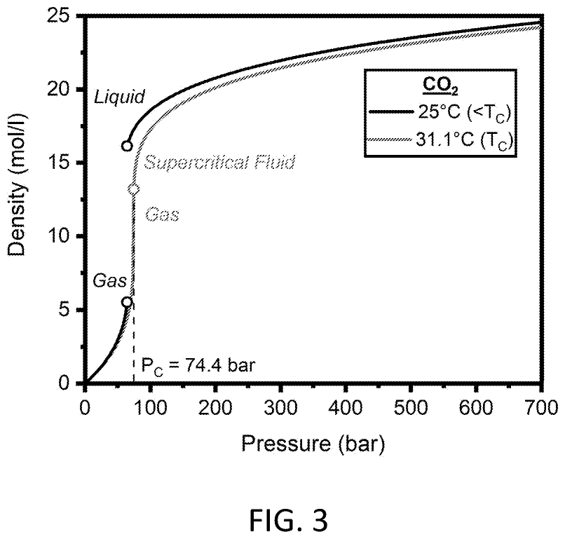

The volume required for fuel/exhaust co-storage is assessed based on the densities and properties of these gases/liquids at elevated pressure. First, the properties of compressed CO₂ are considered to estimate the volume required for storing captured exhaust comprising CO₂. (See FIG. 3.) Note that the ambient-temperature density increases rapidly with increasing pressure up to about 74 bar, and reaches a value of about 21 mol/L at 250 bar. The phase transition from gas to liquid occurs abruptly at about 74 bar. Phase transition is to supercritical fluid above 31.1° C. but with a similar density achieved. Further increases in pressure do increase the density, e.g., to about 24 mol/L at 700 bar, but the increases in pump size and tank strength required may not be worth the increased density, except perhaps in applications where tank size is critical. These values are reasonable in view of the ranges for compressing fluids in existing vehicles, e.g. 250 bar for natural gas vehicles and 700 bar for hydrogen fuel cell vehicles.

The present co-storage tanks, such as tank 100, may be used to store various fuels including hydrocarbons (e.g., methane, propane, gasoline) and alcohols (e.g. ethanol, methanol). Biogas is another fuel that may be used. Except for methane, most common fuels are liquid or become liquefied at elevated pressure. Thus, except for methane, the stored fuel may be in its liquid form. As further described below, SOFCs are the most fuel-flexible type of fuel cell, but external fuel reforming may be required prior to introduction into the SOFC, particularly for higher C-number molecules (e.g. gasoline or diesel). Such a reformer may be included in any of the disclosed energy storage systems. As also further described below, different fuels have different practical advantages (e.g., reforming requirements, handling characteristics of liquid versus gaseous, existing fuel infrastructure) and also slightly different required storage volumes. Together with local availability and cost, these factors will guide selection of the type of fuel to be used.

In order to evaluate the fuel and CO₂ storage volumes, specific fuels are considered in detail below, including methane, gasoline, and ethanol.

Methane: Methane is relatively simple to produce from renewable sources (e.g. from electrolytically-produced hydrogen). Another advantage of methane is that fuel processing for use in SOFCs is relatively simple.

The CH₄ oxidation reaction is:

CH₄+2O₂→2H₂O+CO₂. ΔH=−810 kJ (1)

Assuming that the fuel is pure CH₄, the oxidant is pure oxygen, and that it is completely combusted the only species in the exhaust are H₂O and CO₂ (in reality, the combustion is not complete and low levels of impurities such as H₂ and CO will also be present in the exhaust, as further described below.) The number of moles of CH₄ reactant and CO₂ product in equation (1) are the same. When the products are cooled from SOFC operating temperature (600° C.-800° C.) to near ambient temperature, the H₂O is separated as liquid, leaving concentrated CO₂. Thus, for every mole of CH₄ consumed, a mole of CO₂ is produced, supporting the feasibility of using a single tank to store both CH₄ and CO₂. As shown in FIG. 1, the co-storage tank 100 includes an internal movable or flexible gas-tight partition 104 that separates the CH₄-rich reactant (fuel) and CO₂-rich product (exhaust). In a fully fueled situation, the partition 102 is on, or extends to, the right side of the tank 100 and contains only the CH₄-rich reactant. As the fuel is consumed and the CO₂-rich product produced, the partition moves across the tank 100, or bends, to the left. Upon re-fueling with CH₄, the stored CO₂-rich product (including water and impurities) may be off-loaded, e.g., at a fueling station where it can be stored for conversion to fuel such as by electrolysis with renewable electricity. Thus, a vehicle comprising the tank 100/energy storage system 200 is completely emission free, and the pure water produced can be discarded or stored.

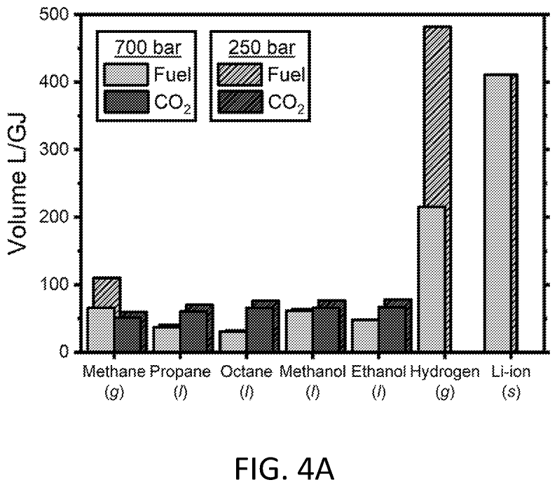

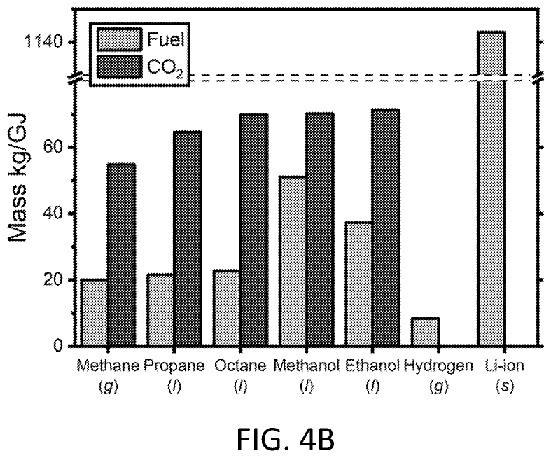

Assuming that the CO₂ is compressed to 700 bar just above the critical temperature for CO₂, where the density in FIG. 2 corresponds to ˜24 mol/l, the CO₂ storage volume required per GJ of reaction enthalpy from methane is 51.4 l/GJ. Note that these units are chosen for convenience since one GJ corresponds to approximately the energy in a small automobile's gasoline fuel tank. The methane density at 700 bar is 18.9 mol/l, leading to a fuel volume of 65.8 l/GJ, slightly higher than that of CO₂ (FIG. 4A). Thus, in this case, the size of the co-storage tank 100 is dictated by the methane storage volume. Note that if the fuel oxidation reaction in eq. 1 is done via combustion with air, where the oxygen is diluted with 4 times as much nitrogen, there would be 8 times as many moles of nitrogen as CO₂ to be stored, and due to the lower density of CH₄ (19 mol/l vs 24 mol/l for CO₂ at 700 bar), would require an ˜10-times larger tank.

Gasoline: Since gasoline consists of a range of different hydrocarbons, for simplicity, a typical one is considered, iso-octane. The oxidation reaction is:

C₈H₁₈+(12.5)O₂→9H₂O+8CO₂, ΔH=−5.46 MJ (2)

The fuel is liquid with a density of 735 g/l (6.44 mol/l) at 700 bar and 706 g/l (6.18 mol/l) at 250 bar. The fuel volume is 30.7 l/GJ at 700 bar and 31.9 l/GJ at 250 bar. The C/H ratio is higher than for CH₄, and hence the amount of CO₂ is greater, leading to a value of 65.2 l/GJ at 700 bar and 75.7 l/GJ at 250 bar. Thus, in this case, the size of the co-storage tank 100 is dictated by CO₂, requiring approximately double the volume as compared to gasoline. Similar results are obtained for other common transportation fuels such as diesel and jet fuel.

Ethanol: The ethanol oxidation reaction is:

C₂H₅OH+3O₂→3H₂O+2CO₂, ΔH=−1.368 MJ (3)

Ethanol is liquid with a density of 780 g/l (17.1 mol/l) that varies little with pressure. The fuel volume is 45.0l/GJ versus 66.9l/GJ for CO₂ at 700 bar, or 46.6l/GJ versus 77.7l/GJ for CO₂ at 250 bar. In this case, CO₂ dictates the size of the co-storage tank 100.

As shown in FIG. 4A, CO₂ storage volume dictates co-storage tank size for all of the liquid fuels, requiring a volume of from 61 to 67l/GJ under a pressure of 700 bar and from 70 to 110l/GJ at 250 bar. In every case except the heavier hydrocarbons, the fuel storage volume and CO₂ storage volume, for the same energy release, are reasonably close. For methane and methanol, the fuel storage volume and CO₂ storage volume are very similar.

For a given fuel energy, the co-storage tank 100 is approximately twice the size of existing fuel tanks in internal combustion engine vehicles. However, considering the greater fuel efficiency of SOFCs (in combination with electric motors) as compared to internal combustion engine vehicles, the co-storage tank 100 is closer to about 1.25 times the size of such existing fuel tanks.

As shown in FIG. 4B, fuel/CO₂ mass was also considered. Compared with the mass of gasoline (about 23 kg/GJ), hydrogen is much lighter (8.33 kg/GJ). However, the mass of a lithium-ion battery (LIB), 1000-3000 kg/GJ, is high enough to comprise a major fraction of vehicle weight. CO₂ storage does lead to larger masses as compared to typical fuels. Specifically, the fuel weight when filled with mostly CO₂ product may be more than twice that of the fuel-only filled tank, about 65 kg/GJ. However, such an increase in weight is not an issue for terrestrial applications. For example, the mass of a GJ worth of petroleum is 22 kg. For a passenger vehicle, a typical GJ-sized tank corresponds to about 2% of total vehicle mass. If such a tank was filled instead with compressed CO₂, the mass increases to only about 4% of total vehicle mass.

Vehicles Incorporating the Energy Storage Systems

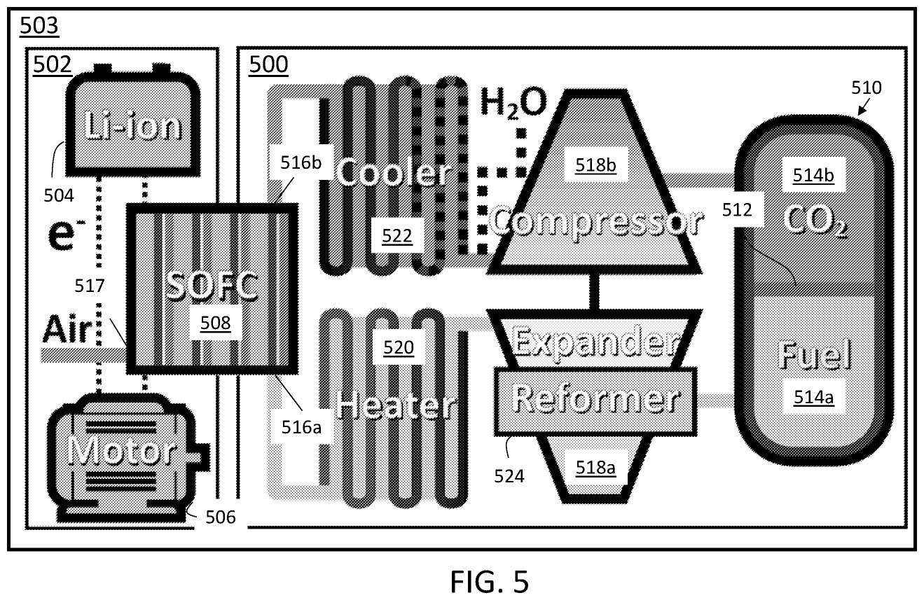

The present co-storage tanks (including co-storage tank 100) and energy storage systems (including energy storage system 200) may be used in various applications, including as part of an energy conversion system in a motorized vehicle. This is illustrated with reference to FIG. 5. This figure shows another illustrative embodiment of an energy storage system 500 which is operatively connected to a hybrid battery system 502 of a vehicle 503. The hybrid battery system 502 comprises a rechargeable battery such as a lithium-ion battery 504 and electric motor 506. The energy storage system 500 comprises a SOFC 508 and a co-storage tank 510. Integration of the SOFC 508 with the hybrid battery system 502 has several advantages. In the hybrid battery system 502, the SOFC 508 provides a fairly steady power output at the average value required by the vehicle 503, effectively keeping the battery 504 charged, while the battery 504 follows rapid changes in load demand. A battery pack 504 that is small by battery electric vehicle (BEV) standards (but typical of plug-in hybrids) can provide the relatively high power required for acceleration and rapid charging during regenerative braking. Compared with existing battery-only or fuel-cell-only vehicles, a fuel-cell/battery hybrid allows for much-reduced fuel cell stack and battery pack sizes.

The energy storage system 500 further comprises the co-storage tank 510 in addition to the SOFC 508. Similar to the tank 100 of FIG. 1, the tank 510 is configured to store both fuel and exhaust. The tank 510 comprises a self-adjustable partition 512 that defines a first chamber 514a in which the fuel is stored and a second chamber 514b in which the exhaust is stored. Any of the fuels described above may be used. The fuel is generally under pressure so that the fuel may be referred to as a pressurized fuel. Depending upon its source, the fuel may comprise other minority components. For example, for CH₄, the minority components may be H₂, CO, CO₂, H₂O. The exhaust comprises CO₂. Similarly, the exhaust comprising CO₂ is typically under pressure so that the exhaust/CO₂ may be referred to as a pressurized exhaust/pressurized CO₂. As noted above, the exhaust may also comprise other components, e.g., H₂, CO, H₂O. However, the exhaust generally does not comprise any N₂. The tank 510 is generally maintained at ambient temperature (or just above, >31.1° C., to avoid CO₂ condensation) but, as described above, the tank 510 (or chambers 514a, b) may be maintained at very high pressures, e.g., in a range of from 250 bar to 700 bar. Thus, the tank 510 and/or the chambers 514a, 514b may be referred to as pressurized.

The SOFC 508 is a stack of individual SOFCs, each comprising an anode, a cathode, and a solid electrolyte separating the anode and the cathode. A variety of designs may be used for the SOFC 508 (i.e., various configurations, compositions, components), provided the design allows the SOFC to convert the fuel into CO₂. The SOFC 508 has an anode inlet port 516a in fluid communication with the first chamber 514a so as to receive the fuel and an anode outlet port 516b in fluid communication with the second chamber 514b so as to release exhaust comprising CO₂ therein. The SOFC 508 has a cathode inlet port 517 in fluid communication with a source of O₂ (e.g., air).

The SOFC 508 may be maintained at high temperature (e.g. 600-850° C.) and atmospheric pressure. Thus, as shown in FIG. 5, the fuel may be first expanded to ambient pressure (via an expander 518a) and then pre-heated to near the operating temperature (via a heater 520). Similarly, the CO₂—H₂O-rich exhaust may be first cooled (via a cooler 522) thereby removing most of the H₂O vapor, and then compressed (via a compressor 518b) for storage in the tank 510. A recuperative heat exchanger that both cools the exhaust and heats the fuel may be used. Alternatively, the SOFC 508 may be configured to operate at high pressure, thereby eliminating a need for the compressor 518b-expander 518a. The system 500 may include a reformer 524 that would partially convert the fuel to H₂ prior to entering the SOFC 508. The compressor 518b-expander 518a may well benefit from having an internal heat exchanger to balance the heat of compression with the cooling of expansion.

Notably, aside from the removal of water via the cooler 522, the exhaust released from the SOFC 508 is directly stored on-board the vehicle 503 via the tank 510. As noted above, this exhaust generally comprises other impurities such as H₂ and CO. Neither the energy storage system 500, the hybrid battery system 502, or the vehicle 503 comprises an oxygen generator to produce O₂ or a burner or other device to process the exhaust by reacting it with either air or O₂ (from the oxygen generator) to remove such impurities. This is advantageous as it reduces complexity, avoids introducing N₂, and increases efficiency.

The SOFC 508 provides a source of power which may be connected to an electrical load. As shown in FIG. 5, this electrical load is the hybrid battery system 502 of the vehicle 503. However, the SOFC 508 (and thus, the energy storage system 500) may be operatively connected to any component requiring electric power (e.g., a home appliance). Regarding vehicles, the type of vehicle is not particularly limiting. A variety of motorized vehicles may incorporate the present co-storage tanks and energy storage systems, including long-haul vehicles such as trucks, buses, marine, trains; light-duty vehicles such as passenger cars; and aircraft. It is also noted that the SOFC 508 could be run in reverse, and thereby used to store electricity (while the vehicle 503 is connected to the grid, e.g., at home) in the form of a fuel in the vehicle 503.

During use, when the fuel in the first chamber 514a of the tank 510 is mostly (or completely) depleted and the second chamber 514b of the tank 510 is mostly (or completely) filled, the system 500 can be re-fueled at a station providing a source of fuel (e.g., high pressure CH₄) The station may also have the ability to off-load the captured CO₂ for storage or use in further conversion to renewable fuel using some type of renewably-powered electrolysis technology.

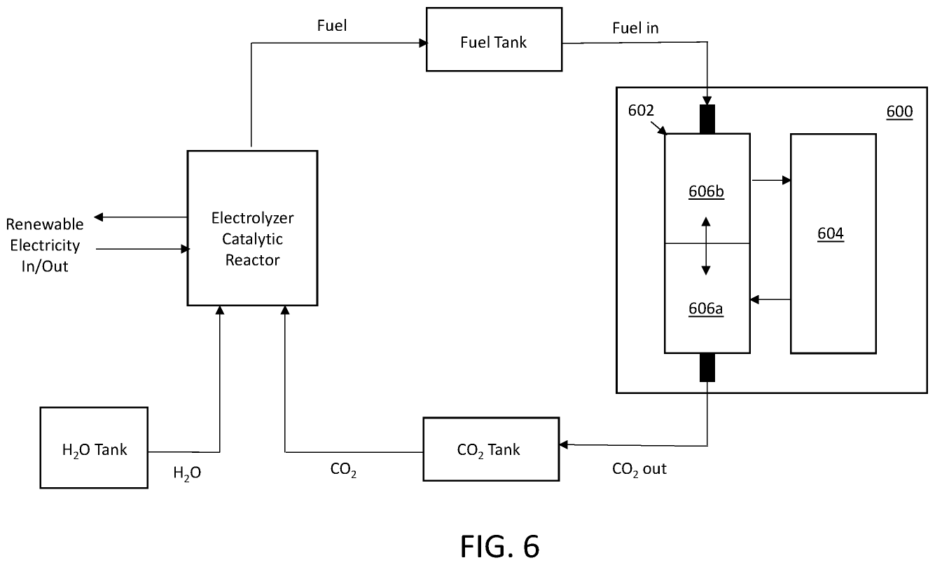

For example, an illustrative embodiment showing an energy storage system 600 operatively connected to a fuel filling station is shown in FIG. 6. The energy storage system 600 is similar to that shown in FIG. 2 (200) comprising a co-storage tank 602 and SOFC 604. One chamber 606a of the tank 602 is in fluid communication with a combined electrolysis and catalysis system configured to convert the CO₂ of the exhaust along with H₂O into a renewable fuel (e.g., one comprising CH₄). Thus, the chamber 606a/tank 602 has an appropriate port/conduit connecting it to the electrolysis/catalysis system. The electrolysis/catalysis system may comprise a solid oxide electrolysis cell (or stack of such cells) configured to convert the CO₂ into the fuel. As another example, the fuel may be generated from a system configured to generate the fuel (e.g., CH₄) from CO₂ and H₂ (e.g., H₂ produced from steam/water electrolysis) using an appropriate catalyst. As also shown in FIG. 6, another chamber 606b of the tank 602 is in fluid communication with the electrolysis/catalysis system so as to receive the renewable fuel. Again, the chamber 606b/tank 602 has an appropriate port/conduit connecting it to the electrolysis/catalysis system. As noted above, the electrolysis/catalysis system may be part of a fuel filling station, i.e., a station equipped both to accept the exhaust comprising CO₂ from the tank 602 of system 600, convert it to renewable fuel, and to provide the renewable fuel back to the tank of system 600. Alternatively, the chamber 606b may be in fluid communication with a different source of the fuel, e.g., a different renewable fuel source or a non-renewable fuel source.

It is to be understood that the energy storage systems 200, 500 and 600 may each comprise fewer, additional, and/or different components as compared to those illustrated in the respective figures. Boxes grouping and separating system components (see e.g., FIG. 5) are also not intended to be limiting. By way of illustration, variations are contemplated such as use of separate tanks (instead of a co-storage tank), one configured to store, under pressure, any of the disclosed fuels and another configured to store, under pressure, the disclosed exhaust comprising CO₂. It is noted that tank size would be about 50 to 100% larger for the separate tank embodiment as compared to a co-storage tank. As another example, variations are contemplated in which any of the disclosed SOFCs are replaced by an oxygen generator and a heat engine (e.g., an internal combustion engine, a turbine) in electrical communication with one another. Similar to the disclosed SOFCs (albeit with less efficiency), the oxygen generator and heat engine operate to convert the fuel to the exhaust for delivery into any of the disclosed tanks (including the co-storage tanks).

Methods of using the present co-storage tanks and energy storage systems are also provided. Illustrative embodiments of such a method can comprise filling the co-storage tank (or an appropriate chamber thereof) with a fuel (e.g., a fuel comprising CH₄). The fuel can be from a renewable source (e.g., from an electrolysis/catalysis system as described above) or a non-renewable source. At this stage, the co-storage tank may not comprise any exhaust (or an appropriate chamber thereof may be empty). Whenever power is needed, the method can comprise introducing O₂ (the source of which may be air) into the cathode inlet port of the SOFC and introducing the fuel into the anode inlet port of the SOFC under conditions (e.g., at an appropriate temperature) to convert the fuel into CO₂ and generate electricity. The CO₂ exits the SOFC as exhaust which is captured/stored in the co-storage tank (or an appropriate chamber thereof). As noted above, the method need not comprise generating any O₂ and/or processing the exhaust (e.g., via a burner) prior to storage. The conversion of fuel to exhaust/CO₂ can continue until the co-storage tank is empty of fuel. To release CO₂ from co-storage tank, the CO₂ can technically be released into the atmosphere. However, as described above, the co-storage tank is desirable so that CO₂ can be offloaded for storage or coupled to an electrolysis/catalysis system configured to convert the CO₂ into a renewable fuel. This renewable fuel can then be used to refill the co-storage tank. Variations are contemplated involving the use of separate tanks instead of the co-storage tanks.

In embodiments, an energy storage system is provided, the system comprising: a co-storage tank configured to store, under pressure, a fuel comprising a hydrocarbon, an alcohol, or both, and an exhaust comprising CO₂, the co-storage tank comprising an outlet port configured to deliver the fuel and an inlet port configured to receive the exhaust; and a SOFC configured to convert the fuel into the exhaust comprising CO₂, the SOFC comprising an anode inlet port configured to connect to the outlet port of the co-storage tank to receive the fuel and an anode outlet port configured to connect to the inlet port of the co-storage tank to release the exhaust.

In embodiments, a co-storage tank for co-storage of a fuel and CO₂ is provided, the tank comprising: walls configured to store, under pressure, a fuel comprising a hydrocarbon, an alcohol, or both, and an exhaust comprising CO₂; an outlet port configured to deliver the fuel to a SOFC configured to convert the fuel into the exhaust comprising CO₂; and an inlet port configured to receive the exhaust from the SOFC. The co-storage tank of claim 19, further comprising a partition that separates the co-storage tank into a first chamber for the fuel and a second chamber for the exhaust. The co-storage tank of claim 20, wherein the partition is self-adjustable. The co-storage tank of claim 19, wherein the fuel comprises CH₄.

It is noted that any of disclosed energy storage systems may be in the form of a module that may be operatively connected to a vehicle, e.g. as a trailer or pod, as desired, e.g., when longer range is needed. For example, any of the disclosed energy storage systems may be configured as a self-contained component that can be attached or removed from a vehicle, e.g., depending on the vehicle range required. Such embodiments are particularly useful for battery electric vehicles configured for short range trips and having a small inexpensive light-weight battery. When going on a longer trip, a user may simply stop at a fueling station, but instead of just fueling, any of the disclosed energy storage systems may be rented and attached via an electrical umbilical (and then returned at the end of the trip).

Additional description of the vehicular applications of the present co-storage tanks and energy storage systems and comparison to existing technologies such as hydrogen and lithium ion batteries are found in U.S. Applications Nos. 62/882,775 and 62/940,316, each of which is incorporated by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

1. A motorized vehicle comprising a device configured to convert a fuel comprising a hydrocarbon, an alcohol, or both, to an exhaust comprising CO₂, and a tank configured to store, under pressure, the exhaust comprising CO₂ and an inlet port configured to receive the exhaust from the device.

2. The motorized vehicle of claim 1, wherein the vehicle does not comprise a device to process the exhaust to remove impurities, other than water, prior to storage in the tank.

3. The motorized vehicle of claim 1, further comprising another tank configured to store, under pressure, the fuel comprising the hydrocarbon, the alcohol, or both and an outlet port configured to deliver the fuel to the device.

4. The motorized vehicle of claim 1, wherein the tank is a co-storage tank configured to store, under pressure, the fuel comprising the hydrocarbon, the alcohol, or both, and the exhaust comprising CO₂, the co-storage tank further comprising an outlet port configured to deliver the fuel to the device.

5. The motorized vehicle of claim 4, further comprising a partition that separates the co-storage tank into a first chamber for the fuel and a second chamber for the exhaust.

6. The motorized vehicle of claim 5, wherein the partition is self-adjustable.

7. The motorized vehicle of claim 1, wherein the device is a solid oxide fuel cell (SOFC) or a heat engine operatively connected to an oxygen generator.

8. The motorized vehicle of claim 4, wherein the device is a SOFC comprising an anode inlet port configured to receive the fuel from the outlet port of the co-storage tank and an anode outlet port configured to deliver the exhaust to the inlet port of the co-storage tank.

9. The motorized vehicle of claim 8, further comprising a partition that separates the co-storage tank into a first chamber for the fuel and a second chamber for the exhaust.

10. The motorized vehicle of claim 9, wherein the partition is self-adjustable.

11. The motorized vehicle of claim 8, wherein the SOFC further comprises a cathode inlet port configured to receive air.

12. The motorized vehicle of claim 8, further comprising a compressor configured to compress the exhaust prior to delivery to the co-storage tank.

13. The motorized vehicle of claim 12, further comprising an expander configured to expand the fuel prior to delivery to the SOFC.

14. The motorized vehicle of claim 8, further comprising a reformer configured to at least partially convert the fuel to H₂ prior to delivery to the SOFC.

15. The motorized vehicle of claim 8, further comprising a rechargeable battery and an electric motor, both in electrical communication with the SOFC.

16. A method of using the motorized vehicle of claim 1, the method comprising converting the fuel into the exhaust comprising CO₂ and capturing the exhaust in the tank.

17. The method of claim 16, wherein the method does not comprise processing the exhaust to remove impurities, other than water, prior to storage in the tank.

18. A method of using the motorized vehicle of claim 8, the method comprising:
flowing air into the SOFC and flowing the fuel from the co-storage tank into the SOFC to convert the fuel into the exhaust comprising CO₂ and generate electricity; and
capturing the exhaust in the co-storage tank.

19. The method of claim 18, further comprising using the electricity to charge a rechargeable battery.

20. The method of claim 18, further comprising releasing the exhaust comprising the CO₂ to a system configured to convert the CO₂ to a renewable fuel.

21. (canceled)
